(19) United States
(12) Patent Application Publication
(10) Pub. No.: US 2020/0166059 A1
(43) Pub. Date: May 28, 2020

(54) PIEZOELECTRIC BIMORPH SERVO VALVE

(71) Applicant: Hamilton Sundstrand Corporation, Charlotte, NC (US)

(72) Inventors: Maciej Bujewicz, Wroclaw (PL); Marcin Korczynski, Wroclaw (PL)

(21) Appl. No.: 16/516,869

(22) Filed: Jul. 19, 2019

(30) Foreign Application Priority Data
Nov. 27, 2018 (EP) 18461635.7

(51) Int. Cl. F15B 13/043; F16K 1/18; F16K 31/00

(52) U.S. Cl. CPC F15B 13/043; F16K 31/006; F16K 1/18

(57) ABSTRACT

A hydraulic servo valve is described herein comprising a servovalve body with first and second nozzles and a flapper provided therein, wherein said flapper is a bimorph piezoelectric flapper and comprises: a first layer of piezoelectric material and a second layer of piezoelectric material. The servovalve further comprises means for providing a positive voltage to one of said first and second layers and a negative voltage to the other of said first and second layers, and the flapper extends longitudinally between a first end and a second end. The second end of said flapper is positioned so as to be between said first and second nozzles so that said first layer faces said first nozzle and said second layer faces said second layer.

### FOREIGN PRIORITY

This application claims the benefit of European Patent Application No. 18461635.7 filed Nov. 27, 2018, the entire contents of which is incorporated herein by reference.

### FIELD

The examples described herein relate to the field of servovalves.

### BACKGROUND

Servovalves are somewhat complicated structures with complex and expensive parts. They also contain seals that are vulnerable to leakage. Servovalves are also difficult to assemble and calibrate. It would therefore be useful to provide a servovalve that overcomes these problems and that further allows the servovalve to be better sealed.

U.S. Pat. No. 9,447,797 B1 describes a deflector jet servovalve assembly comprising a piezoelectric actuator that is joined to a flow guide and feedback gear. The piezoelectric element is fitted within a slot at one end and attached at its second end to the flow guide.

U.S. Pat. No. 4,825,894 describes a piezoelectric torque motor that includes a body and a pair of opposed nozzle assemblies mounted on the body. The piezoelectric actuator is a stack of individual crystals.

U.S. Pat. No. 4,535,810 describes an electrically controlled valve using a piezoelectric strip as an actuator.

### SUMMARY

A hydraulic servo valve is described herein comprising a servovalve body with first and second nozzles and a flapper provided therein, wherein said flapper is a bimorph piezoelectric flapper and comprises: a first layer of piezoelectric material and a second layer of piezoelectric material. The servovalve further comprises means for providing a positive voltage to one of said first and second layers and a negative voltage to the other of said first and second layers, and the flapper extends longitudinally between a first end and a second end. The second end of said flapper is positioned so as to be between said first and second nozzles so that said first layer faces said first nozzle and said second layer faces said second layer. One of said first and second layers is configured to contract in a direction away from one of said nozzles and wherein the other of said first and second layers is configured to extend in the direction of the other of said nozzles when said voltages are applied to said flapper.

The servovalve may further comprise a third layer positioned between said first and second layers.

In some examples, the flapper may extend along a longitudinal axis L from said first end to said second end, and the first layer may extend longitudinally between said first end and said second end. The second layer may extend longitudinally between said first end and said second end.

In some examples, the first layer and second layer have different thicknesses to each other.

In some examples, the flapper is made from layers of more than one different type of piezoelectric material.

In some examples, the layers have different geometries to each other.

In some examples, the valve body may be formed from a single component.

In some examples, the flapper is attached at its first end to a bracket.

In some examples, the flapper is connected at its first end to wiring, said wiring being said means for providing said first and second voltages.

In some examples, servovalve body comprises a supply port, a control port and a return port which are in fluid communication with said nozzles.

In some examples, a cover may be provided over said flapper and over said means for providing said first and second voltages.

In some examples described herein, the servovalve does not comprise an armature assembly having a plate and a torsion bridge.

In any of the examples described herein, the servovalve may be sealed without the use of an O-ring.

A method of making a servovalve is also described herein comprising: providing first and second nozzles and a flapper within a servovalve body wherein said flapper is a bimorph piezoelectric flapper and comprises: a first layer of piezoelectric material and a second layer of piezoelectric material, said method further comprising: providing means for providing a positive voltage to one of said first and second layers and a negative voltage to the other of said first and second layers, and wherein said flapper extends longitudinally between a first end and a second end and the method further comprising positioning said flapper so that said second end of said flapper is between said first and second nozzles and said first layer faces said first nozzle and said second layer faces said second layer, and wherein said one of said first and second layers is made from a material that is configured to contract in a direction away from one of said nozzles and wherein the other of said first and second layers is made from a material that is configured to extend in the direction of the other of said nozzles (180b) when said voltages are applied to said flapper.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1a illustrates a cross-sectional view of a known servovalve

FIG. 1b illustrates a cross-sectional view of the known servovalve of FIG. 1a, with a cover provided thereon.

FIG. 2 illustrates a cross-sectional view of a new type of servovalve as described herein.

FIG. 3 illustrates an exploded view of the new type of servovalve of FIG. 2.

FIG. 4 depicts the internal and external features of the new type of servovalve 200 described herein.

FIG. 5a depicts the new type of flapper described herein when connected to the bracket.

FIG. 5b depicts the flapper reacting to an electric current being applied thereto.

FIG. 6 depicts a cross-section of the new type of servovalve showing air gaps between the end of the flapper and the nozzles.

### DETAILED DESCRIPTION

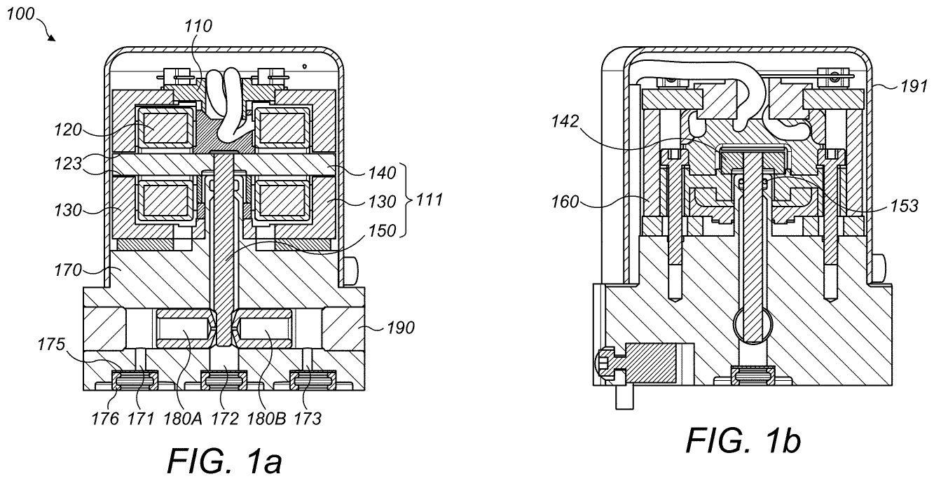

The examples described herein relate to servovalves. A known servovalve 100 is shown in FIGS. 1a and 1b. The servovalve comprises wire routing 110, and an armature assembly 111 with a flapper 150 extending therefrom. The armature assembly 111 specifically comprises a pole piece, 130 and a plate 140 that is supported by a torsion bridge 142 as is known in the art. As can be seen in FIG. 1b, an O-ring 153 is provided between the flapper 150 and the section of the servovalve body through which the flapper 150 extends. Air gaps 123 are present between the pole pieces 130 and the horizontally extending plate 140. Magnetic coils 120 are also provided and wound around a permanent magnet 160. The flapper 150 extends through the body 170 of the servovalve 100 and is positioned so as to extend between two nozzles 180. Lee plugs 190 may also be provided. The body 170 of the servovalve comprises three ports: a supply port 171, a control port 172 and a return port 173. The control ports may also comprise filters 175 and/or screen rings 176.

A cover 191 may also be provided over the armature assembly as shown in FIG. 1b. When a current is applied to the coils 120, magnetic flux acting on the ends of the armature 150 is developed. The direction of the magnetic flux (force) depends on the sign (direction) of the current. The magnetic flux will cause the armature move either left or right, i.e. in the direction of one of the nozzles and in the direction away from the other nozzle.

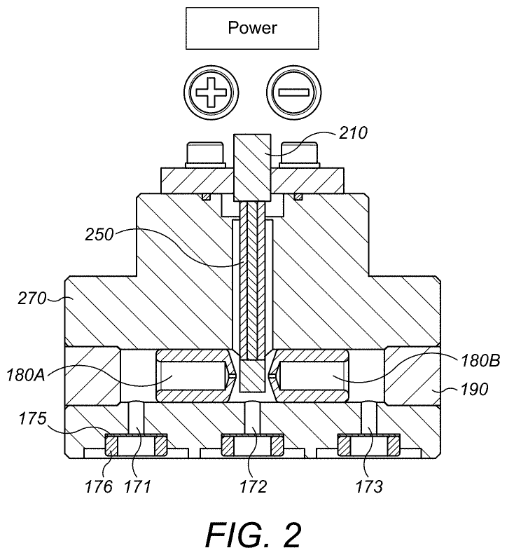

A new type of servovalve 200 is shown in FIG. 2. The same reference numerals have been used to represent the corresponding features as shown in FIGS. 1a and 1b. As can be seen in FIG. 2, however, the whole upper part of the servovalve including the armature assembly, coils, etc. has been removed and is no longer required. Instead, this new servovalve 200 has a flapper 250 that is made from a piezoelectric material.

Specifically, in this new servovalve, the following components are no longer required or present: 1) the armature assembly which includes the assembly of the plate, torsion bridge (and the known type of flapper 150 being replaced by the new type of flapper 250)—(3 elements), 2) the coils 120—(2 elements), 3) covers over the coils—(2 elements), wire routings—(2 elements) and 4) torque motor fix screws—(2 elements), 5) pole piece, top and bottom (2 elements), 6) the O-ring inside the valve body (1 element), 7) the rubber gasket on top of the pole piece—(1 element).

That is, except for the flapper 150 being replaced with a new type of flapper 250 as described below, the new type of servovalve 200 described herein does not comprise any of the features in this list.

This new type of servovalve 200 is different to known servovalves because it uses a bimorph piezoelectric element/material as the flapper. This bimorph piezoelectric flapper 250 comprises two layers assembled together to form the flapper. Such bimorph materials comprise two active layers, wherein one layer contracts while the other layer expands upon the supply of voltage. In some examples, a passive layer may also be provided between the two active layers. Due to the relative contraction and expansion, the flapper 250 bends. The degree to which it bends will depend on the voltage polarization on one of the layers, either positive or negative. Electricity is provided to the flapper via wire routing 210.

Depending on the voltage that is applied to the flapper 250, the flapper 250 will bend to one side, or the other. In this way, the distance between the nozzles and the flapper 250 is changed and so also the amount of medium or fluid that is able to flow through the nozzles 180 is also changed. The flapper 250 movement is caused by a change in the size of the piezoelectric material, i.e. the relative shortening and lengthening of the two layers (that may be separated by a neutral layer). Depending on which layer receives the positive or negative voltage, the bending of the flapper towards one of the nozzles and the deflection from the other nozzle can be achieved.

In some examples, the flapper 250 can be made from layers of materials having different geometries and this can also affect the bending of the flapper 250.

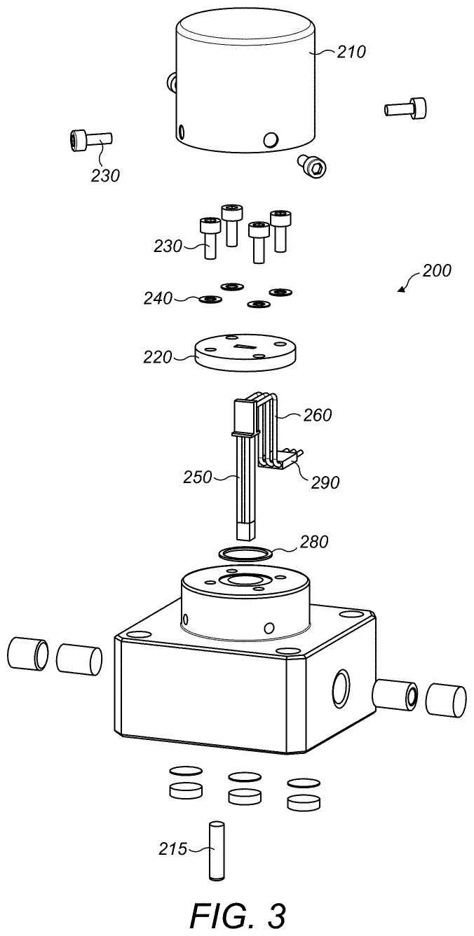

FIG. 3 depicts an exploded view of the new type of servovalve 200 that is shown in FIG. 2. This figure shows how the servovalve 200 may be assembled. The servovalve body 270 may be formed as one single component. This differs from known servovalve bodies which may be formed of multiple components that are assembled together. The servovalve 200 may also have a cover 210 which may be connected to a piezoelectric bracket 220 via screws 230 and washers 240. The flapper 250 is electrically connected to a power/voltage source via wires 260. A rubber seal 290 and a copper seal 280 may also be used. The rubber seal 290 serves to seal the servovalve 200 so that no dirt can get inside the cover 210. The copper seal 280 serves to seal the servovalve 200 so that there is no leakage of fuel from inside to outside and to keep the servovalve 200 tightly sealed from the environment.

The nozzles 180a, 180b are again provided so as to be positioned within the servovalve body 270 so that they are either side of the flapper 250. The servovalve 200 body 270 also has three ports, i.e. a supply port 171, a control port 172 and a return port 173, as is described above with reference to FIGS. 1a and 1b. A pin 215 may be used during assembly to accurately position the valve. The use of the pin 215 may also prevent the incorrect installation of the valve, e.g. preventing the operator from switching or misaligning the ports.

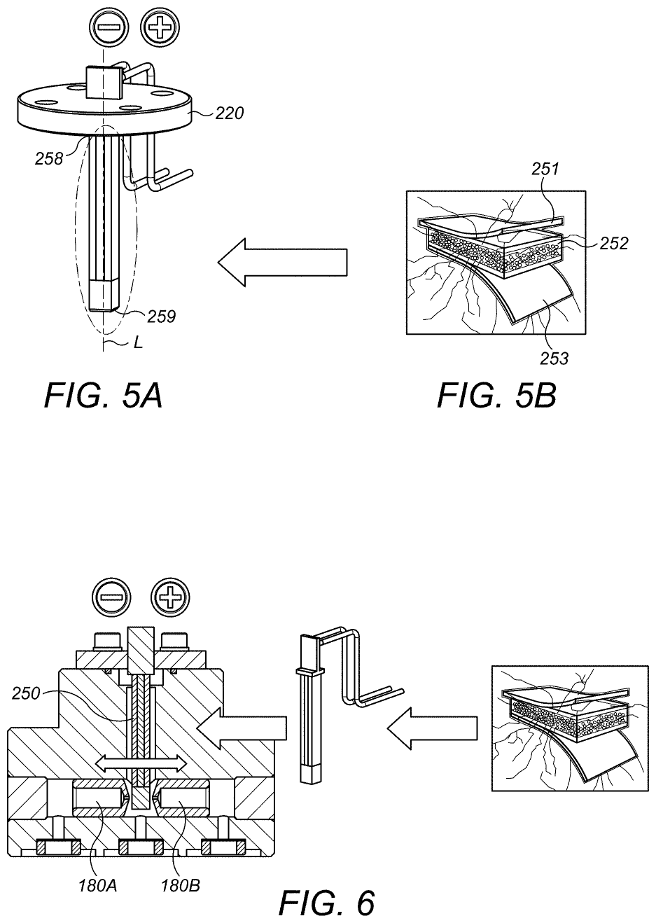

As can be seen in FIG. 5a, the flapper 250 comprises an elongated cylindrical component that extends along a longitudinal axis L from a first end 258 to a second end 259. The layers 251, 252 and 253 also extend longitudinally between the first end 258 and the second end 259 and are positioned on opposite longitudinal sides of the flapper 250 to each other. The flapper 250 is positioned between the nozzles 180a, 180b so that one of the layers 251 faces one nozzle 180a while the other layer 253 faces the other nozzle 180b. In the new servovalve 200 the second end 259 of the flapper is positioned between the nozzles 180a, 180b whereas the voltage is applied to the flapper 250 at its first end 258.

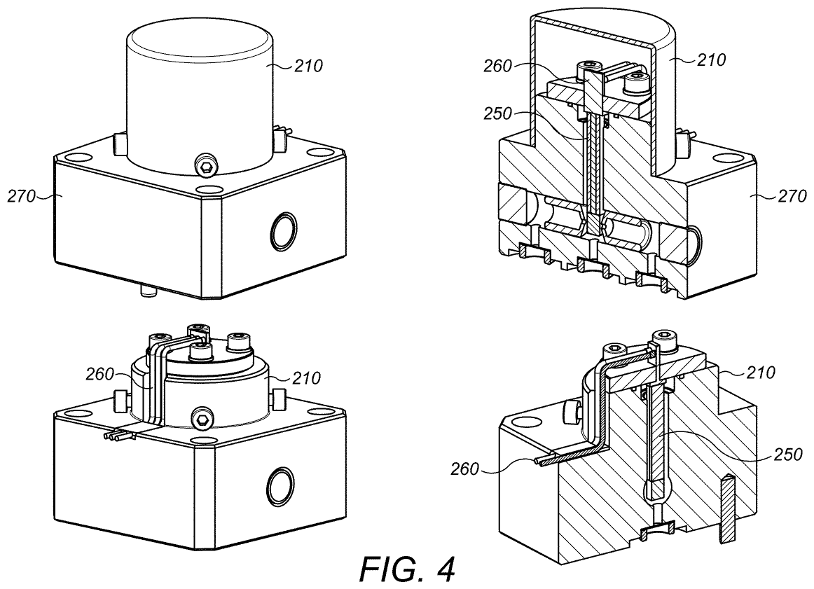

FIG. 4 depicts the internal and external features of the new type of servovalve 200 and shows how the wiring may be positioned relative to the servovalve body 290.

FIG. 5a depicts the new type of flapper 250 connected to the bracket 220 and FIG. 5b depicts how the different layers 251, 252, 253 of the flapper 250 react to a voltage being applied thereto. In this figure, the layers 251 and 253 are the active layers, one of which is receiving a negative voltage and one of which is receiving a positive voltage. The passive layer 252 is sandwiched between these two active layers 251, 253. The passive layer 252 does not receive any voltage and does not contract or expand.

FIG. 6 depicts a cross-section of the new type of servovalve 200 showing air gaps 700 between the end of the flapper 250 and the nozzles 180a, 180b. Upon application of a positive voltage to a first active layer 251 and a simultaneous negative voltage to the second active layer 253, the bimorph piezoelectric flapper 250 bends left/right and in the direction away from and to the nozzles 180a, 180b.

A method of making this new type of servovalve 200 may comprise providing first 180a and second 180b nozzles and the new type of flapper 250 within the servovalve body 270. As discussed above, the flapper 250 is a bimorph piezoelectric flapper 250 and comprises a first layer 251 of piezoelectric material and a second layer 252 of piezoelectric material. The method of making the servovalve may further comprise providing means 260 (i.e. a power source) for providing a positive voltage to one of the first and second layers 251, 252 and a negative voltage to the other of the first and second layers 252. As also discussed above, the flapper 250 extends longitudinally between a first end 258 and a second end 259 and so the method may further comprise positioning the flapper so that said second end 259 of the flapper 250 is between the first 180a and second nozzles 180b. The first layer 251 faces the first nozzle 180a and the second layer 253 faces the second layer 253.

One of the first and second layers 251, 253 is made from a material that is configured to contract in a direction away from one of the nozzles and the other of the first and second layers 251, 252 is made from a material that is configured to extend in the direction of the other of the nozzles 180b when the voltages are applied to the flapper 250.

The method of making the servovalve may also comprise making the servovalve to have any of the above discussed features, such as making/providing the flapper 250 so that is further comprises a third layer 252 positioned between the first 251 and second layers 253.

The method may also comprise making/providing a flapper 250 so that the first layer 251 and the second layer 253 have different thicknesses to each other. The method may also comprise making the flapper/providing the flapper so that it is made from layers of more than one piezoelectric material.

The method may also comprise making the flapper/providing the flapper so that the layers have different geometries to each other.

The method may also comprise forming the servovalve body 270 so that it is a single component and not made up from different components that are then assembled together.

The method may also comprise attaching the flapper 250 at its first end 258 to the bracket 220.

The method may also comprise connecting the flapper 250 at its first end 258 to wiring, the wiring being said means for providing the first and second voltages.

The method may also comprise providing the servovalve body with a supply port 171, a control port 172 and a return port 173 which are in fluid communication with the nozzles 180a, 180b.

The method may further comprise providing a cover 210 over the flapper 250) and the wiring that provides the first and second voltages.

The method may also comprise hermetically sealing the servovalve.

These new types of servovalves and methods for making the same as described herein provide significant advantages over known servovalves. For example, they simplify the structure of the torque motor, and remove the need for complicated and expensive parts. They also eliminate the need for the vulnerable O-rings seals which are found in known servovalves. They also eliminate the need for brazed connections. In addition to this, they eliminate the difficult problem of cutting the air gaps between the pole pieces and the plate. The examples described herein also allow for the servovalve to be hermetically sealed so that the valve is closed off from contamination by dirt, dust etc.

1. A hydraulic servo valve comprising:
a servovalve body with first and second nozzles and a flapper provided therein,
wherein said flapper is a bimorph piezoelectric flapper and comprises:
a first layer of piezoelectric material and
a second layer of piezoelectric material,
and wherein said servovalve further comprises
means for providing a positive voltage to one of said first and second layers and a negative voltage to the other of said first and second layers, and
wherein said flapper extends longitudinally between a first end and a second end and wherein said second end of said flapper is positioned so as to be between said first and second nozzles so that said first layer faces said first nozzle and said second layer faces said second layer, and
wherein said one of said first and second layers is made from a material that is configured to contract in a direction away from one of said nozzles and wherein the other of said first and second layers is made from a material that is configured to extend in the direction of the other of said nozzles when said voltages are applied to said flapper.

2. The servovalve of claim 1 wherein said flapper further comprises a third layer positioned between said first and second layers.

3. The servovalve of claim 1, wherein said flapper extends along a longitudinal axis L from said first end to said second end, and wherein said first layer extends longitudinally between said first end and said second end and wherein said second layer extends longitudinally between said first end and said second end.

4. The servovalve of claim 1, wherein said first layer and said second layer have different thicknesses to each other.

5. The servovalve of claim 1, wherein the flapper is made from layers of more than one piezoelectric material.

6. The servovalve of claim 1, wherein said layers have different geometries to each other.

7. The servovalve of claim 1, wherein said servovalve body is formed from a single component.

8. The servovalve of claim 1, wherein said flapper is attached at its first end to a bracket.

9. The servovalve of claim 1, wherein said flapper is connected at its first end to wiring, said wiring being said means for providing said first and second voltages.

10. The servovalve of claim 1, wherein said servovalve body comprises a supply port, a control port and a return port which are in fluid communication with said nozzles.

11. The servovalve of claim 1, wherein a cover is provided over said flapper and said means for providing said first and second voltages.

12. The servovalve of claim 1, wherein the servovalve is hermetically sealed.

13. The servovalve of claim 1, wherein said servovalve does not comprise an armature assembly having a plate and a torsion bridge.

14. The servovalve of claim 1, wherein said servovalve is sealed without the use of an O-ring.

15. A method of making a servovalve comprising:
providing first and second nozzles and a flapper within a servovalve body, wherein said flapper is a bimorph piezoelectric flapper and includes a first layer of piezoelectric material and a second layer of piezoelectric material; and
providing means for providing a positive voltage to one of said first and second layers and a negative voltage to the other of said first and second layers, and
wherein said flapper extends longitudinally between a first end and a second end and the method further comprising positioning said flapper so that said second end of said flapper is between said first and second nozzles and said first layer faces said first nozzle and said second layer faces said second layer, and
wherein said one of said first and second layers is made from a material that is configured to contract in a direction away from one of said nozzles and wherein the other of said first and second layers is made from a material that is configured to extend in the direction of the other of said nozzles when said voltages are applied to said flapper.
